(19) United States
(12) Patent Application Publication
(10) Pub. No.: US 2018/0006541 A1
(43) Pub. Date: Jan. 4, 2018

(54) SINGLE PHASE MOTOR AND ROTOR THEREOF

(71) Applicant: Johnson Electric S.A., Murten (CH)

(72) Inventors: Yue LI, Hong Kong (CN); Chui You ZHOU, Shenzhen (CN); Jie CHAI, Shenzhen (CN); Tao ZHANG, Shenzhen (CN); Yong WANG, Shenzhen (CN)

(21) Appl. No.: 15/632,980

(22) Filed: Jun. 26, 2017

(30) Foreign Application Priority Data
Jul. 1, 2016 (CN) 2016 1051 8353.X
Jul. 1, 2016 (CN) 2016 1051 9474.6

(51) Int. Cl. H02K 21/14; H02K 21/24; H02K 29/08; H02K 13/00

(52) U.S. Cl. CPC H02K 21/145; H02K 29/08; H02K 21/24; H02K 13/00

(57) ABSTRACT

A single phase motor includes an excitation part and an armature part. The excitation part includes N magnets that result in 2N magnetic poles being formed on the excitation part, and the armature part includes 2N tooth portions forming 2N pole portions, where N is an integer greater than one. The present invention further provides a rotor for the single phase motor. The present invention allows each magnet to be fully used, reduces the number of the magnets used in the single phase phase and the workload during motor assembly, as well as reduces the motor fabriction cost.

### CROSS REFERENCE TO RELATED APPLICATIONS

This non-provisional patent application claims priority under 35 U.S.C. §119(a) from Patent Application No. 201610518353.X and Patent Application No. 201610519474.6 both filed in The People's Republic of China on Jul. 1, 2016.

### FIELD OF THE INVENTION

The present invention relates to the field of motors, and in particular to a single phase permanent magnet motor.

### BACKGROUND OF THE INVENTION

In a permanent rotor utilized by the most common single phase permanent magnet motors in the market, the number of permanent magnets is equal to the number of magnetic poles of the rotor, and sides of adjacent magnets facing a stator have opposite polarities and cooperatively form a magnetic circuit. In this type of permanent rotors with a large amount of magnets, the magnets are often not fully used. In addition, assembly of the rotor becomes complicated, which is adverse to lowering cost.

### SUMMARY OF THE INVENTION

Therefore, there is a desire for an improved single phase permanent magnet motor which can effectively reduce the fabrication cost of the single phase permanent magnet motor.

In one aspect, a single phase motor comprises an excitation part and an armature part. The excitation part comprises N magnets that result in 2N magnetic poles being formed on the excitation part, and the armature part comprises 2N tooth portions forming 2N pole portions, where N is an integer greater than one.

Preferably, the armature part further comprises 2N coils wound around the 2N tooth portions, respectively.

Preferably, the armature part further comprises N coils wound around N of the tooth portions, each tooth portion with coil is located between two tooth portions without coil.

Preferably, the armature part comprises a stator, the excitation part comprises a rotor rotatable relative to the stator, and the stator comprises the 2N tooth portions extending toward the rotor.

Preferably, the rotor is a surface mounted permanent magnet rotor comprising a rotor core, and the N magnets are arranged on a circumferential surface of the rotor core at even intervals.

Preferably, N grooves are defined in the circumferential surface of the rotor core and arranged at even intervals, and the N magnets are affixed to or mounted in the grooves, respectively.

Preferably, each groove is an arc groove or a flat-bottomed groove, each of the magnets is an arcuate magnet, and an outer circumferential edge of the magnet is located on a circular arc centered at an axis of the rotor.

Preferably, each groove is an arc groove or a flat-bottomed groove, each of the magnets is an arcuate magnet, and a distance from an outer side surface of each magnet to an axis of the rotor progressively decreases from a circumferential middle toward two ends of the magnet.

Preferably, sides of the N magnets close to the rotor core have the same polarity.

Preferably, the rotor is an insert permanent magnet rotor comprising a rotor core, and the N magnets are mounted in the rotor core and arranged at even intervals.

Preferably, N grooves for accommodating the N magnets are defined in the rotor core and arranged at even intervals, two gaps are respectively defined between two ends of each groove and a corresponding one of the magnets accommodated in the groove, a circumferential surface of the rotor is cut to form 2N planes, and the gaps at the two ends of each groove are located adjacent two of the planes, respectively.

Preferably, sides of the N magnets facing the stator have the same polarity.

In another aspect, a rotor for a single phase motor is provided. The rotor comprises a rotor core and N magnets mounted or affixed to the rotor core, and the N magnets make the rotor form 2N magnetic poles, where N is an integer greater than one.

Preferably, the N magnets are mounted to a circumferential surface of the rotor core and arranged at even intervals.

Preferably, a distance from an outer side surface of each magnet to an axis of the rotor progressively decreases from a circumferential middle toward two ends of the magnet.

Preferably, sides of the N magnets close to the rotor core have the same polarity.

Preferably, the N magnets are inserted in the rotor core and arranged at even intervals.

Preferably, N grooves for accommodating the N magnets are defined in the rotor core and arranged at even intervals, two gaps are respectively defined between two ends of each groove and one corresponding magnet accommodated in the each groove, a circumferential surface of the rotor is cut to form 2N planes, and the gaps at the two ends of each groove are located adjacent two of the planes, respectively.

Preferably, sides of the N magnets facing the stator have the same polarity.

Implementation of the present invention can reduce the number of the permanent magnets used in the single phase permanent magnet motor, which facilitates the motor assembly and reducing of the motor fabrication cost.

### BRIEF DESCRIPTION OF THE DRAWINGS

The present invention is described below in greater detail with reference to the drawings and embodiments.

FIG. 1 is a sectional view of a single phase brushless direct current motor according to one embodiment of the present disclosure.

FIG. 2 is a diagram showing a magnetic field distribution of the single phase brushless direct current motor of FIG. 1.

FIG. 3 is a diagram showning back-EMF and cogging torque of the single phase brushless direct current motor of FIG. 1 with respect to a rotation time of a rotor of the single phase brushless direct current motor.

FIG. 4 is a sectional view of a single phase brushless direct current motor according to another embodiment of the present disclosure.

FIG. 5 is a sectional view of a single phase brushless direct current motor according to a third embodiment of the present disclosure.

FIG. 6 is a diagram showing a magnetic field distribution of the single phase brushless direct current motor of FIG. 5.

FIG. 7 is a diagram showning back-EMF and cogging torque of the single phase brushless direct current motor of FIG. 5 with respect to a rotation time of a rotor of the single phase brushless direct current motor.

FIG. 8 is a sectional view of a single phase brushless direct current motor according to a fourth embodiment of the present disclosure.

### DETAILED DESCRIPTION OF THE PREFERRED EMBODIMENTS

Embodiments of the present invention will be described in greater detail with reference to the drawings. It should be noted that the figures are illustrative rather than limiting. The figures are not drawn to scale, do not illustrate every aspect of the described embodiments, and do not limit the scope of the present disclosure. Unless otherwise specified, all technical and scientific terms used in this disclosure have the ordinary meaning as commonly understood by people skilled in the art.

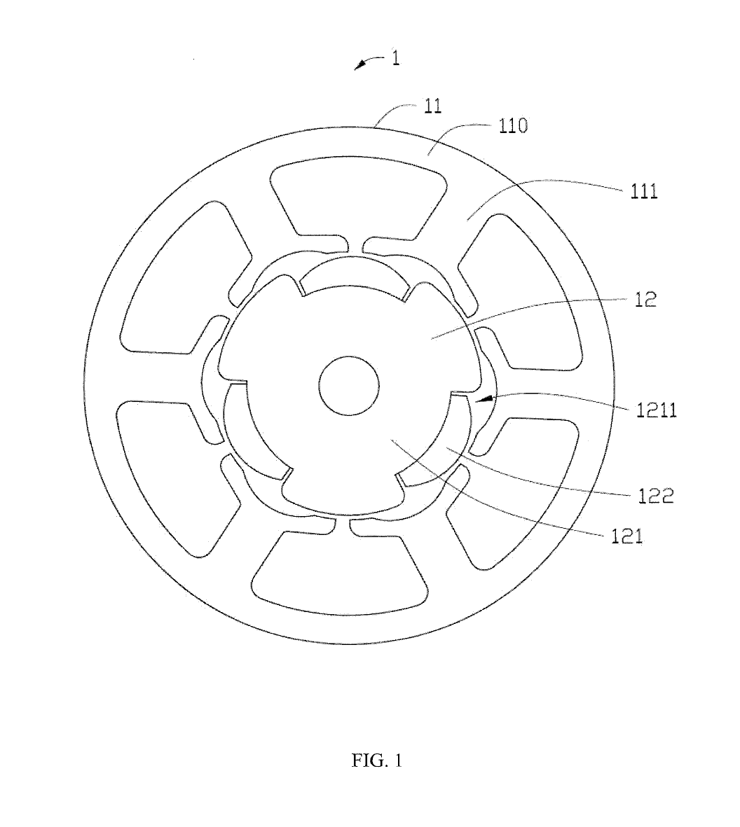

FIG. 1 is a sectional view of a single phase brushless direct current motor according to one embodiment of the present disclosure. The motor 1 includes an armature part and an excitation part. The armature part includes a stator 11, and the excitation part includes a rotor 12 rotatable relative to the stator. The stator 11 includes a plurality of tooth portions 111 extending toward the rotor 12 and arranged at even intervals. The plurality of tooth portions 11 form a plurality of pole portions. Coils (not shown) are wound around all or part of the tooth portions 111. The rotor 12 is a surface mounted permanent magnet rotor, including a rotor core 121 and a plurality of permanent magnets 122 affixed to or mounted to an outer circumferential surface of the rotor core 121. The rotor core 121 is made of a magnetic conductive material such as silicon steel sheets. A number of the permanent magnets 122 is half of a number of the tooth portions 111. Sides of the permanent magnets 122 affixed to or mounted to the rotor core 121 have the same polarity, i.e. are all north poles or all south poles.

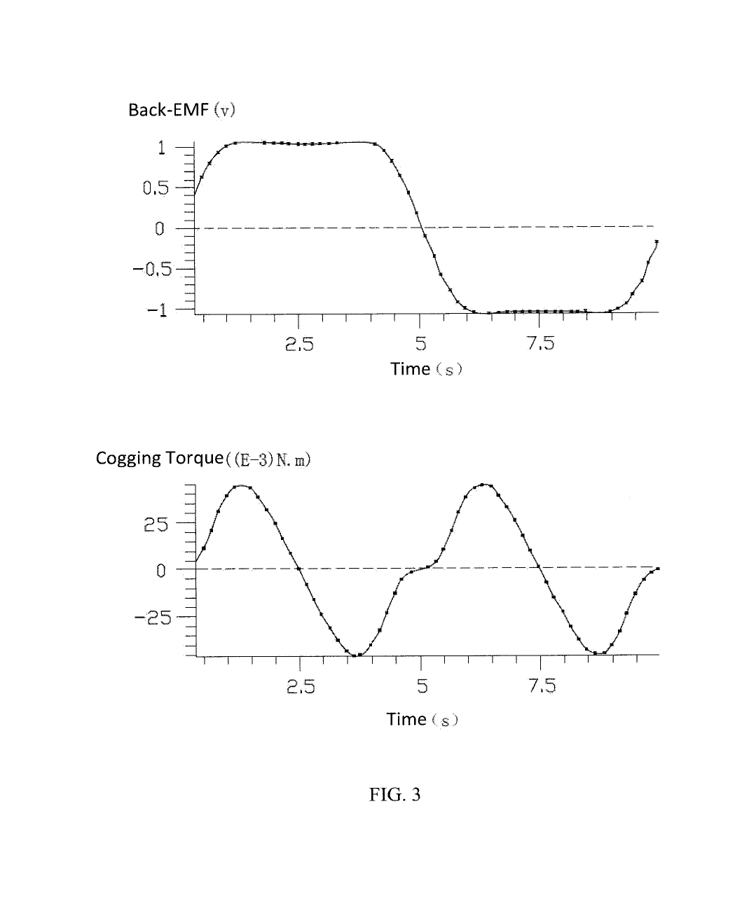

In the embodiment of FIG. 1, the stator 11 includes a ring-shaped yoke 110 and six tooth portions 111 extending from an inner side of the yoke 110 toward the rotor and arranged at even intervals, and the six tooth portions 111 form six pole portions. The six tooth portions 111 can be all wound with the coils, or can be alternatively wound with the coils, i.e. only three tooth portions 111 are wound with the coils, and the tooth portions with coils wound thereon and the tooth portions without coils wound thereon are alternatively arranged. The number of the permanent magnets 122 is three. The rotor core 121 is cylindrical shaped. A plurality of uniformly sized grooves 1211 is defined in an outer circumferential surface of the rotor core 121 and arranged at even intervals. The grooves 1211 extend from one end to the other end of the rotor core 121 and each have an arc-shaped cross-section. A center of a circle on which the arc-shaped grooves 1211 are located is located on a center axis of the rotor core 121. The permanent magnets 122 are affixed to or mounted in the grooves 1211, respectively. In an alternative embodiment, the outer circumferential surface of the rotor core 121 is cut to form a plurality planes arranged at even intervals, and the permanent magnets 122 are affixed to or mounted to the planes. The permanent magnet 122 is arcuate in shape. In one embodiment, outer circumferential edges of the permanent magnets 122 are located on a circular arc centered at the axis of the rotor 12. In an alternative embodiment, a middle of the permanent magnet 122 is thicker than two ends thereof, i.e. a distance from an outer side surface of each permanent magnet 122 to the axis of the rotor progressively decreases from a circumferential middle toward two ends of the permanent magnet 122. Therefore, an air gap between the ends of the permanent magnet 122 and the stator tooth portions 111 is greater than an air gap between the middle of the permanent magnet 122 and the stator tooth portion 111, such that the cogging torque generated during operation of the motor 1 has a waveform closer to a sine wave as shown in FIG. 3, which thus results in more stable operation and lowered noise of the motor 1 and increases performance and lifespan of the motor 1.

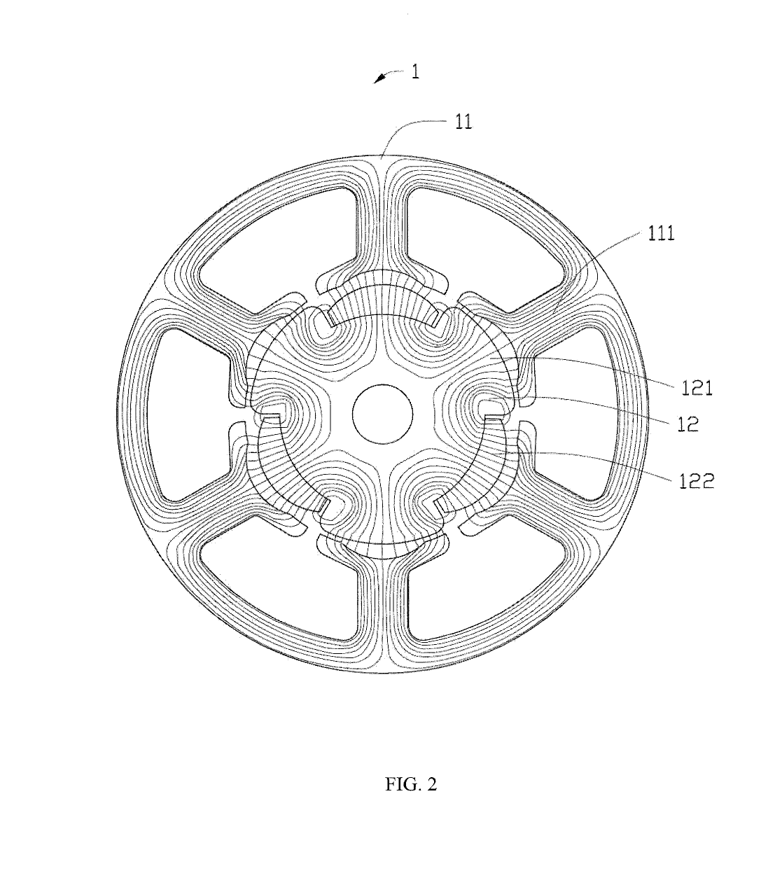

Referring to FIG. 2, in each permanent magnet 122, magnetic lines start from its north pole, travel through the stator 11 and back to its south pole along two paths, thus forming two magnetic circuits. As such, the three permanent magnets 122 form six magnetic poles, and each magnetic circuit includes only one permanent magnet. Therefore, each magnet can be fully used, and the number of motor parts and hence cost can be reduced.

The motor is illustrated above as including a surface mounted permanent magnet rotor having three magnets forming six magnetic poles. It is to be understood that, in various other embodiments, the number N (N is an integer greater than one) of the magnets may vary to form a surface mounted permanent magnet rotor with 2N magnetic poles when used in combination with 2N pole portions of the stator.

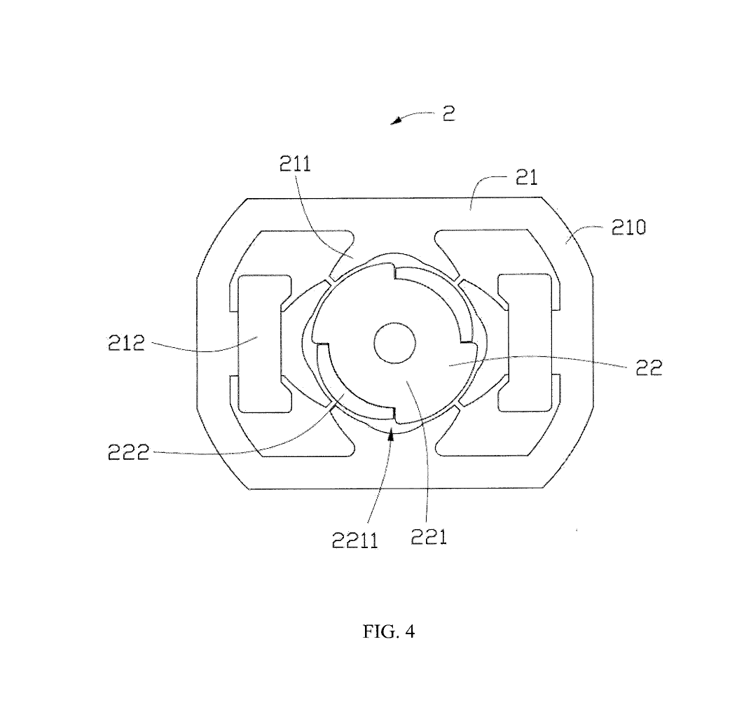

FIG. 4 illustrates an exemplary embodiment in which a surface mounted permanent magnet rotor has two magnets forming four magnetic poles and the stator tooth portions are partially wound with coils. Referring to FIG. 4, the stator 21 of the motor 2 includes a yoke 210 having a substantially rectangular ring shape and four tooth portions 211 extending from the yoke 210 toward the rotor 22. The four tooth portions 211 forming four pole portions. The tooth portions 211 are alternatively wound with the coils, i.e. only two opposed tooth portions 211 are wound with the coils 212. Two uniformly sized arc grooves 2211 are symmetrically defined in an outer circumferential surface of a rotor core 221 of the rotor 22. The permanent magnets 222 are affixed to or mounted in the arc grooves 2211. In each permanent magnet 222, magnetic lines start from its north pole, travel through the tooth portion 211 and back to its south pole along two paths. Therefore, four magnetic poles are formed.

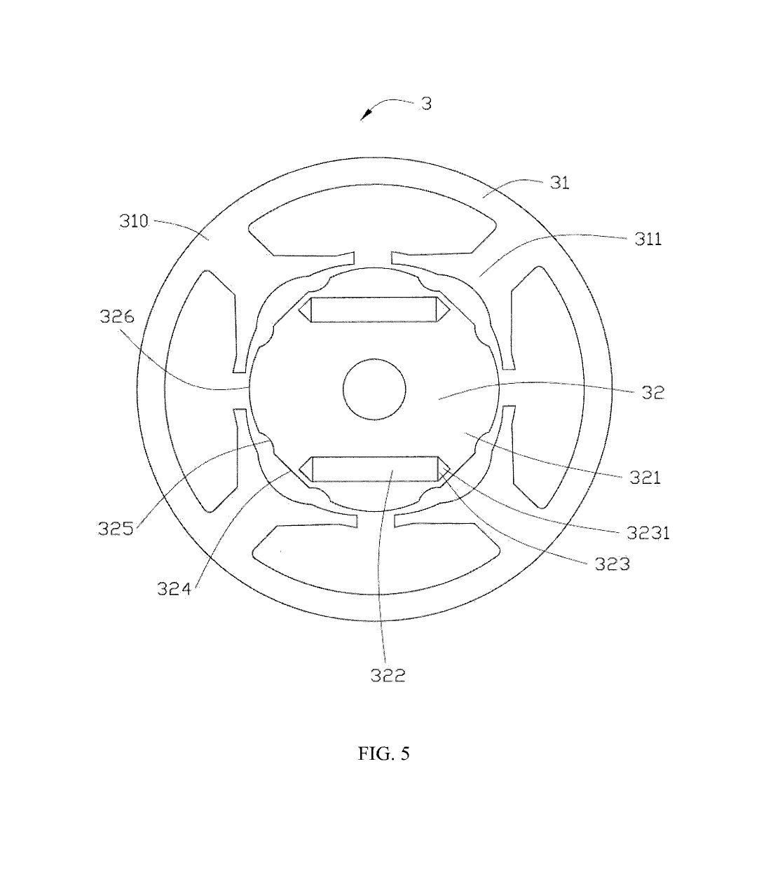

FIG. 5 is a sectional view of a single phase brushless direct current motor according to another embodiment of the present disclosure. The motor 3 includes an armature part and an excitation part. The armature part includes a stator 31, and the excitation part includes a rotor 32 rotatable relative to the stator 31. The stator 31 includes a plurality of tooth portions 311 extending toward the rotor 32 and arranged at even intervals. The plurality of tooth portions 31 form a plurality of pole portions. Coils (not shown) are wound around all or part of the tooth portions 311. The rotor 32 is an insert permanent magnet rotor, including a rotor core 321 and a plurality of permanent magnets 322 inserted in the rotor core 321. A number of the permanent magnets 322 is half of a number of the tooth portions 311. Sides of the permanent magnets 322 adjacent the stator 31 have the same polarity, i.e. are all north poles or all south poles. In the embodiment of FIG. 5, the stator 31 includes a yoke 310 and four tooth portions 311 extending from an inner side of the yoke 310 toward the rotor 32 and arranged at even intervals, and the four tooth portions 311 form four pole portions. The four tooth portions 311 can be all wound with the coils, or can be alternatively wound with the coils, i.e. only two tooth portions 311 are wound with the coils, and the tooth portions 311 with coils wound thereon and the tooth portions 311 without coils wound thereon are alternatively arranged. The number of the permanent magnets 322 is two, and the two permanent magnets 322 are inserted in the rotor core 321, surrounding an axis of the rotor core 321 and arranged at an even interval.

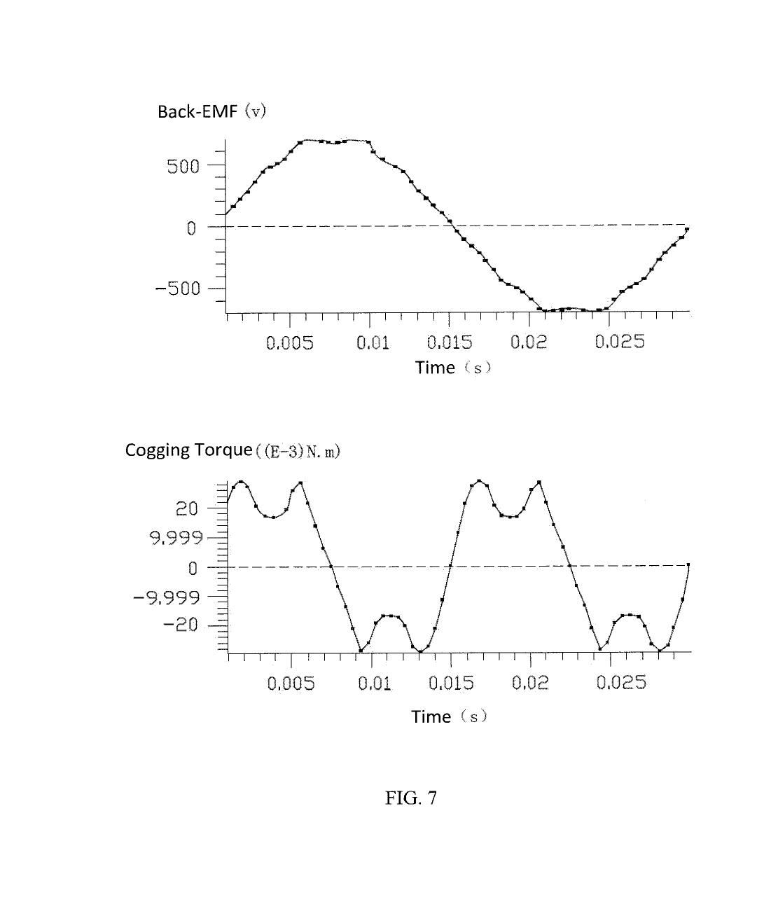

Specifically, in the embodiment of FIG. 5, two uniformly sized grooves 323 are defined in the rotor core 321 of the rotor 32, which surround the axis of the rotor core 321 at an even interval. The permanent magnets 322 are respectively inserted in the grooves 323, with gaps 3231 defined at two ends of each groove 323. The rotor core 321 is cylindrical shaped, with arc surfaces located on its outer surface. The outer surface of the rotor core 321 is cut to form a plurality of planes 324, and each plane 324 is located adjacent the gap 3231 at one end of a corresponding groove 323 to reduce magnetic leakage. In the embodiment of FIG. 5, corresponding to the gaps 3231 at four ends of the two grooves 323, there are four such planes 324 evenly arranged along the outer circumferential surface of the rotor 32. In addition, arc recesses 325 are defined at two sides of each plane 324 on the circumferential surface of the rotor 32. Each arc recess 325 interconnects one plane 324 and one adjacent arc surface 326 to reduce magnetic leakage. In the embodiment of FIG. 5, the provisions of the planes 324 and the arc recesses 325 increase the air gap between the corresponding location of the rotor core 321 and the stator tooth portion 311, such that the cogging torque generated during operation of the motor 3 has a waveform closer to a sine wave as shown in FIG. 7, which thus results in more stable operation and lowered noise of the motor 3 and increases performance and lifespan of the motor 3.

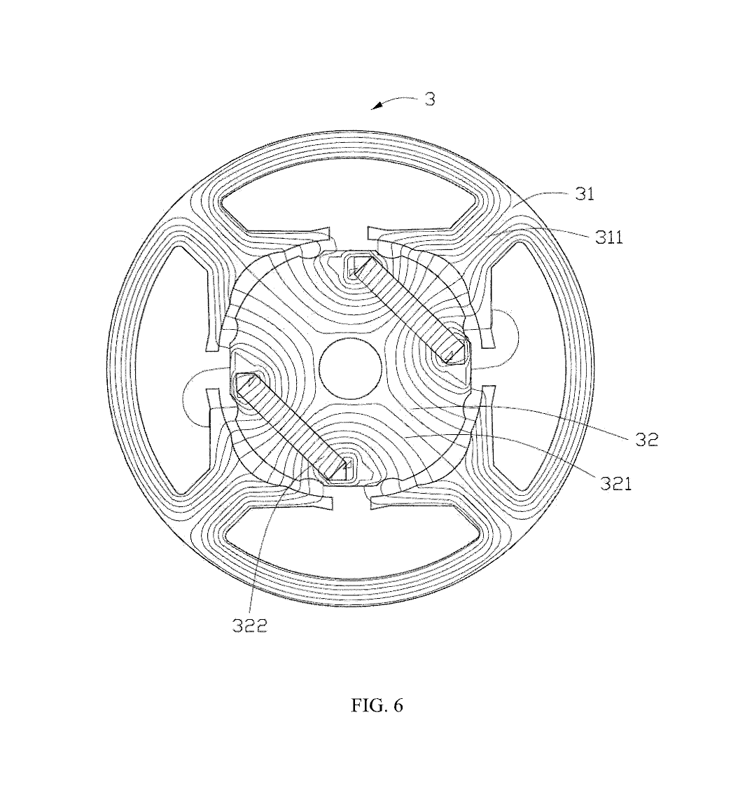

Referring to FIG. 6, in each permanent magnet 322, magnetic lines start from its north pole, travel through the stator 31 and back to its south pole along two paths, thus forming two magnetic circuits. As such, the two permanent magnets 322 form four magnetic poles, and each magnetic circuit includes only one permanent magnet. Therefore, each magnet can be fully used, and the number of the motor parts and hence cost can be reduced.

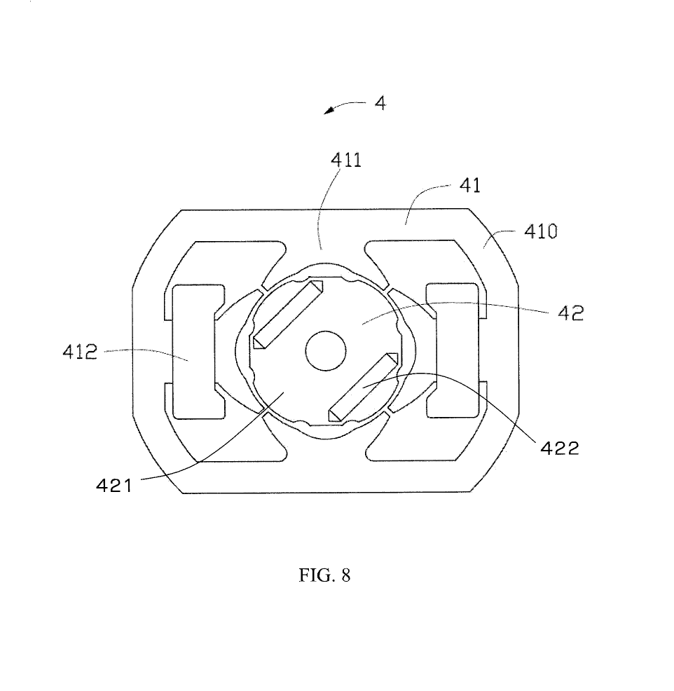

FIG. 8 illustrates a motor 4 having a stator 41. The stator 41 includes a yoke 410 having a substantially rectangular ring shape and four tooth portions 411 extending from the yoke 410 toward the rotor 42. The four tooth portions 411 form four pole portions. The tooth portions 411 are alternatively wound with the coils, i.e. only two opposed tooth portions 411 are wound with the coils 412. The rotor 42 is an insert permanent magnet rotor with two magnets inserted therein, and can be formed as a four-pole permanent magnet rotor when used in combination with four pole portions of the stator 41.

The single phase motor is illustrated above as including an insert permanent magnet rotor having two magnets forming four magnetic poles. It is to be understood that, in various other embodiments, the number N (N is an integer greater than one) of the magnets may vary to form an insert permanent magnet rotor with 2N magnetic poles when used in combination with 2N pole portions of the stator.

While the use of N magnets to form 2N magnetic poles is described to be used in an inner rotor motor, it is noted, however, that the use of N magnets to form 2N magnetic poles can be equally used in an outer rotor motor. In this case, for a surface mounted permanent magnet rotor, the N magnets are affixed to or mounted to an inner surface of the rotor core; for an insert permanent magnet rotor, the N magnets are inserted in an interior of the rotor core.

In alternative embodiments, the single phase motor may also be a single phase permanent magnet motor such as a single phase alternative current motor.

In summary, in the single phase motor of the present disclosure, the rotor can form 2N magnetic poles by using N permanent magnets on the rotor in combination with 2N pole portions on the stator, which reduces the number of the magnets, allows each magnet to be fully used, reduces the workload during motor assembly, as well as reduces the motor fabriction cost.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated herein should not be interpreted as limits to the present invention, and the scope of the invention is to be determined by reference to the claims that follow.

1. A single phase motor comprising:
an armature part comprising 2N tooth portions forming 2N pole portions, where N is an integer greater than one; and
an excitation part comprising N magnets that result in 2N magnetic poles being formed on the excitation part.

2. The single phase motor of claim 1, wherein the armature part further comprises 2N coils wound around the 2N tooth portions, respectively.

3. The single phase motor of claim 1, wherein the armature part further comprises N coils wound around N of the tooth portions, each tooth portion with coil is located between two tooth portions without coil.

4. The single phase motor of claim 1, wherein the armature part comprises a stator, the excitation part comprises a rotor rotatable relative to the stator, and the stator comprises the 2N tooth portions extending toward the rotor.

5. The single phase motor of claim 4, wherein the rotor is a surface mounted permanent magnet rotor and comprises a rotor core, and the N magnets are arranged on a circumferential surface of the rotor core at even intervals.

6. The single phase motor of claim 5, wherein N grooves are defined in the circumferential surface of the rotor core and arranged at even intervals, and the N magnets are affixed to or mounted in the grooves, respectively.

7. The single phase motor of claim 6, wherein each groove is an arc groove or a flat-bottomed groove, each of the magnets is an arcuate magnet, and an outer circumferential edge of the magnet is located on a circular arc centered at an axis of the rotor.

8. The single phase motor of claim 6, wherein each groove is an arc groove or a flat-bottomed groove, each of the magnets is an arcuate magnet, and a distance from an outer side surface of each magnet to an axis of the rotor progressively decreases from a circumferential middle toward two ends of the magnet.

9. The single phase motor of claim 5, wherein sides of the N magnets close to the rotor core have the same polarity.

10. The single phase motor of claim 4, wherein the rotor is an insert permanent magnet rotor and comprises a rotor core, and the N magnets are mounted in the rotor core and arranged at even intervals.

11. The single phase motor of claim 10, wherein N grooves for accommodating the N magnets are defined in the rotor core and arranged at even intervals, two gaps are respectively defined between two ends of each groove and a corresponding one of the magnets accommodated in the groove, a circumferential surface of the rotor is cut to form 2N planes, and the gaps at the two ends of each groove are located adjacent two of the planes, respectively.

12. The single phase motor of claim 10, wherein sides of the N magnets facing the stator have the same polarity.

13. A rotor for a single phase motor, comprising a rotor core and N magnets mounted or affixed to the rotor core, the N magnets making the rotor form 2N magnetic poles, where N is an integer greater than one.

14. The rotor of claim 13, wherein the N magnets are mounted to a circumferential surface of the rotor core and arranged at even intervals.

15. The rotor of claim 14, wherein a distance from an outer side surface of each magnet to an axis of the rotor progressively decreases from a circumferential middle toward two ends of the magnet.

16. The rotor of claim 14, wherein sides of the N magnets close to the rotor core have the same polarity.

17. The rotor of claim 13, wherein the N magnets are inserted in the rotor core and arranged at even intervals.

18. The rotor of claim 17, wherein N grooves for accommodating the N magnets are defined in the rotor core and arranged at even intervals, two gaps are respectively defined between two ends of each groove and one corresponding magnet accommodated in the each groove, a circumferential surface of the rotor is cut to foam 2N planes, and the gaps at the two ends of each groove are located adjacent two of the planes, respectively.

19. The rotor of claim 17, wherein sides of the N magnets facing the stator have the same polarity.
